(19) United States
(12) Patent Application Publication
(10) Pub. No.: US 2012/0002104 A1
(43) Pub. Date: Jan. 5, 2012

(54) PORTABLE DISPLAY APPARATUS OF VIDEO SIGNAL

(75) Inventors: Chia-Hsin Chen, Taipei City (TW); Wen-Chieh Chiang, Taipei City (TW)

(73) Assignee: BEYOND INNOVATION TECHNOLOGY CO., LTD., TAIPEI CITY (TW)

(21) Appl. No.: 13/108,007

(22) Filed: May 16, 2011

(30) Foreign Application Priority Data
Jul. 2, 2010 (TW) 99121854

(51) Int. Cl. H04N 7/01

(52) U.S. Cl. 348/441; 348/E07.003

(57) ABSTRACT

A portable display apparatus of a video signal including a video signal source, a signal masking module, and a display panel is provided. The video signal source generates a data enable signal and a clock signal. The signal masking module is electrically connected to the video signal source, receives the data enable signal and the clock signal, and masks a part of the clock signal according to the data enable signal and a masking signal to provide a processing signal. The display panel is electrically connected to the signal masking module, receives the processing signal, and displays a part of the video signal to be an image according to the processing signal.

### CROSS-REFERENCE TO RELATED APPLICATION

This application claims the priority benefit of Taiwan application serial no. 99121854, filed Jul. 2, 2010. The entirety of the above-mentioned patent application is hereby incorporated by reference herein and made a part of this specification.

### BACKGROUND OF THE INVENTION

1. Field of the Invention

The present invention relates to a portable display apparatus, in particular, to a portable display apparatus, capable of adjusting a resolution of a video signal.

2. Description of Related Art

In recent years, with the popularity of a portable display apparatus, the portable display apparatus becomes an indispensable electronic product in modern life, in which a mobile phone market is the fastest growing market. As the mobile phone market is greatly developed, a panel suitable for the mobile phone (such as a panel of a Micro Controller Unit (MCU) interface) is manufactured in large quantities, so as to display video data to be images for being viewed by users.

As the format of the video data is different from the format of the MCU interface, and the resolution of the video data and the resolution of the panel of the MCU interface are different, an image processor and a frame buffer are configured in the mobile phone, and the frame buffer has the resolution equivalent to the resolution of the panel of the MCU interface, so as to enable the resolution of the video data to conform to the resolution of the panel. The image processor is used for processing the video data and storing the processed video data to the frame buffer. Then, the data stored in the frame buffer is gradually converted into the data having required format of the MCU interface through the image processor, and is transmitted to the panel of the MCU interface, so as to display the video signal conforming to the resolution of the panel. However, the frame buffer is required to be configured in the portable display device using a display panel of the mobile phone, so that a use cost of a circuit element is increased.

### SUMMARY OF THE INVENTION

Accordingly, the present invention is directed to a portable display apparatus of a video signal, so as to convert a resolution of the video signal into a resolution conforming to a display panel of a general mobile phone without using an extra frame buffer, thereby reducing a use cost of a circuit and achieving an effect of simplifying the circuit.

The present invention provides a portable display apparatus of a video signal, which includes a video signal source, a signal masking module, and a display panel. The video signal source is used for generating a data enable signal and a clock signal. The signal masking module is electrically connected to the video signal source, and used for receiving the data enable signal and the clock signal, and masking a part of the clock signal according to the data enable signal and a masking signal to provide a processing signal. The display panel is electrically connected to the signal masking module, and used for receiving the processing signal, and displaying a part of the video signal to be an image according to the processing signal.

In an embodiment of the present invention, the portable display apparatus of the video signal further includes a reset signal generating module and a selecting unit. The reset signal generating module generates a reset signal to initialize the display panel. The selecting unit is coupled to the signal masking module and the reset signal generating module, and selects to output the reset signal or the processing signal to the display panel according to a control signal. Furthermore, the selecting unit may be a multiplexer.

In an embodiment of the present invention, the portable display apparatus of the video signal further includes a control unit. The control unit is coupled to the selecting unit, and receives a vertical synchronization signal to generate the control signal and the masking signal.

In an embodiment of the present invention, the signal masking module includes an AND gate and a NAND gate. A first input end of the AND gate receives the data enable signal, a second input end of the AND gate receives the masking signal, and an output end of the AND gate generates an adjusting signal. A first input end of the NAND gate receives the adjusting signal, a second input end of the NAND gate receives the clock signal, and an output end of the NAND gate generates the processing signal.

In an embodiment of the present invention, a resolution of the image is smaller than a resolution of the video signal.

According to the present invention, a signal masking module masks a part of a clock signal of a video signal according to a masking signal and a data enable signal of the video signal, and then a display panel displays the video signal to be an image according to the masked clock signal without converting the video signal through a frame buffer, so as to adjust a resolution of the video signal. In this way, according to the present invention, the extra frame buffer is not required to be configured, therefore, a use cost of a circuit may be effectively reduced and architecture of a portable display apparatus may also be simplified.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a portable display apparatus of a video signal according to an embodiment of the present invention.

FIG. 2 is a timing chart of a data enable signal, a clock signal, a masking signal, and a processing signal according to an embodiment of the present invention.

FIG. 3 is a schematic view of a portable display apparatus of a video signal according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

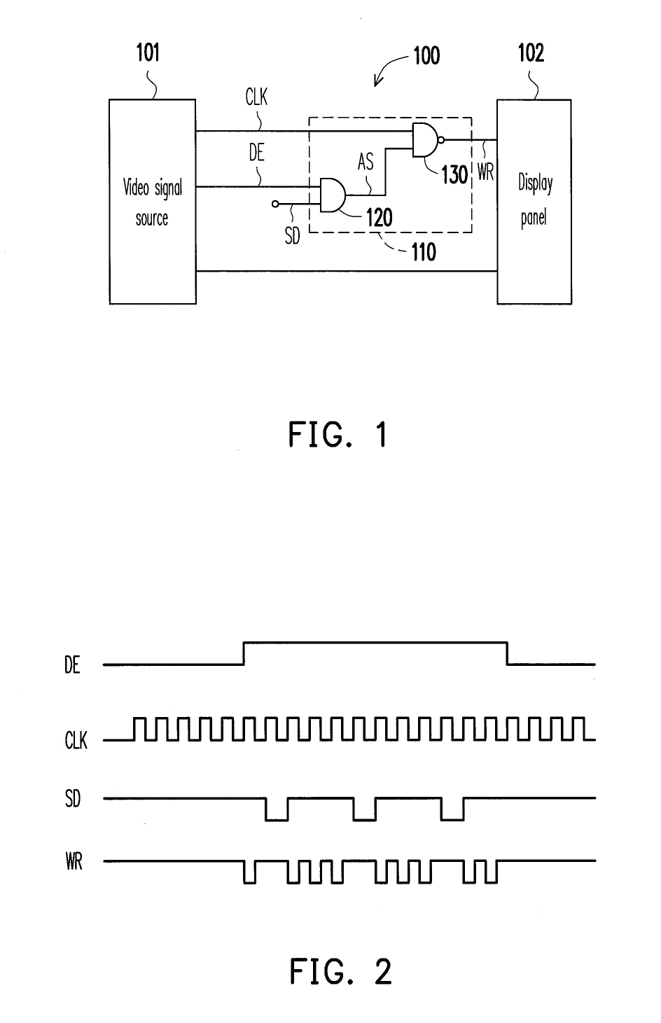

FIG. 1 is a schematic view of a portable display apparatus of a video signal according to an embodiment of the present invention. Referring to FIG. 1, the portable display apparatus of the video signal 100 includes a video signal source 101, a signal masking module 110, and a display panel 102, in which the display panel 102 may be a panel of an MCU interface. The signal masking module 110 is electrically connected to the video signal source 101, receives a data enable signal DE and a clock signal CLK generated by the video signal source 101, and masks a part of the clock signal CLK according to the data enable signal DE and a masking signal SD, so as to generate a processing signal WR (that is, the masked clock signal CLK) to the display panel 102.

Then, the display panel 102 displays a part of the video signal received from the video signal source 101 to be an image according to the processing signal WR. As the processing signal WR used as a reference by the display panel 102 is the masked clock signal CLK, a resolution of the image displayed by the display panel 102 is smaller than a resolution of the video signal generated by the video signal source 101, so as to facilitate adjusting the video signal to have the same resolution with the display panel 102.

Furthermore, the signal masking module 110 includes an AND gate 120 and a NAND gate 130. A first input end of the AND gate 120 receives the data enable signal DE, a second input end of the AND gate 120 receives the masking signal SD, and an output end of the AND gate 120 generates an adjusting signal AS. A first input end of the NAND gate 130 receives the adjusting signal AS, a second input end of the NAND gate 130 receives the clock signal CLK, and an output end of the NAND gate 130 generates the processing signal WR.

An operation manner of the signal masking module 110 is described by referring to a signal timing chart in FIG. 2 below. FIG. 2 is a timing chart of the data enable signal DE, the masking signal SD, the clock signal CLK, and the processing signal WR according to an embodiment of the present invention. Referring to FIGS. 1 and 2, when both the data enable signal DE and the masking signal SD are a logic high voltage level “1”, the adjusting signal AS outputted by the AND gate 120 is the logic high voltage level “1”; when both the data enable signal DE and the masking signal SD are a logic low voltage level “0” or one of the data enable signal DE and the masking signal SD is the logic low voltage level “0”, the adjusting signal AS outputted by the AND gate 120 is the logic low voltage level “0”.

When both the clock signal CLK and the adjusting signal AS are the logic low voltage level “0”, the processing signal WR outputted by the NAND gate 130 is the logic high voltage level “1”; when both the clock signal CLK and the adjusting signal AS are the logic high voltage level “1” or one of the clock signal CLK and the adjusting signal AS is the logic high voltage level “1”, the processing signal WR outputted by the NAND gate 130 is the logic high voltage level “0”.

In FIG. 2, it can be seen that a part of the clock signal CLK may be effectively masked by operating the AND gate 120 and the NAND gate 130, so as to generate the processing signal WR. Since a part of the clock signal CLK is masked (that is, the processing signal WR), when the display panel 102 displays a part of the video signal to be the image according to the processing signal WR, a part of pixels are not displayed. Therefore, the resolution of the image displayed by the display panel 102 is decreased. In this way, a part of the clock signal CLK is masked through the portable display apparatus of the video signal 100, so that the resolution of the image displayed by the display panel 102 is decreased to conform to the resolution of the display panel 102 without the conventional frame buffer. Therefore, according to this embodiment, the use cost of the circuit may be effectively reduced and the structure of the circuit may also be simplified.

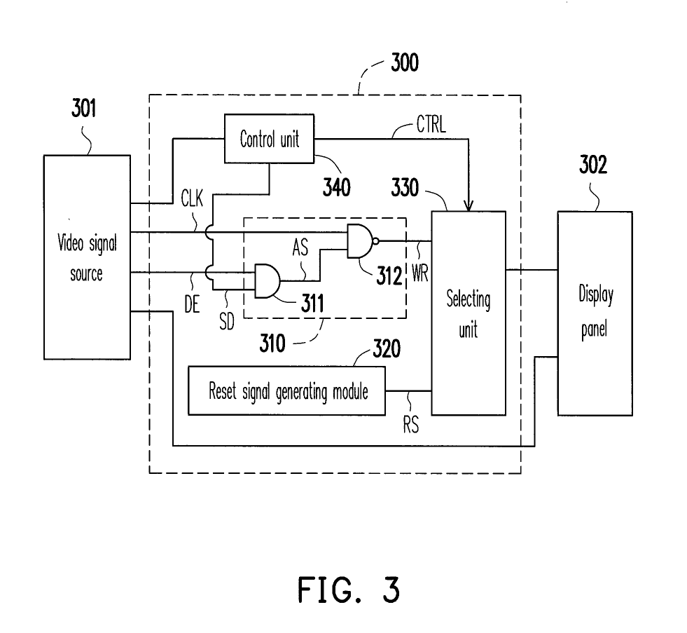

FIG. 3 is a schematic view of a portable display apparatus of a video signal according to another embodiment of the present invention. Referring to FIG. 3, the portable display apparatus of the video signal 300 includes a video signal source 301, a display panel 302, a signal masking module 310, a reset signal generating module 320, a selecting unit 330, and a control unit 340.

In this embodiment, implementation of the video signal source 301, the display panel 302, and the signal masking module 310 may refer to implementation of the video signal source 101, the display panel 102, and the signal masking module 110 in FIG. 1, so the details will not be repeated herein again. Furthermore, the signal masking module 310 may further include an AND gate 311 and a NAND gate 312, a coupling relation and implementation of the AND gate 311 and the NAND gate 312 may refer to a coupling relation and implementation of the AND gate 120 and the NAND gate 130 in FIG. 1, so the details will not be repeated herein again.

The reset signal generating module 310 generates a reset signal SR to initialize the display panel 302. For example, when the display panel 302 receives the reset signal SR, a ram pointer of a Graphic Random Access Memory (GRAM) in the display panel 302 returns to a start position, so as to write video data and display the image.

The selecting unit 330 is coupled to the signal masking module 310 and the reset signal generating module 320, and selects to output the reset signal SR or a processing signal WR to the display panel 302 according to a control signal CTRL. Furthermore, the selecting unit 330 in this embodiment may be a multiplexer. For example, when the control signal CTRL is a logic low voltage level “0”, the selecting unit 330 outputs the reset signal SR to the display panel 302, so as to initialize the display panel 302; when the control signal CTRL is a logic high voltage level “1”, the selecting unit 330 outputs the processing signal WR to the display panel 302, so as to adjust a resolution of the video signal to conform to a resolution of the display panel 302.

The control unit 340 is coupled to the selecting unit 330, and receives a vertical synchronization signal (VSYNC) VSS from the video signal source 301 to generate the control signal CTRL and a masking signal SD. For example, when the control unit 340 fails to receive the VSS, the control signal CTRL outputted by the control unit 340 is the logic low voltage level “0”; and when the control unit 340 receives the VSS, the control signal CTRL outputted by the control unit 340 is the logic high voltage level “1”.

Then, an operation manner of the portable display apparatus of the video signal 300 is described. Firstly, when the portable display apparatus of the video signal 300 starts and the control unit 340 fails to receive the VSS generated by the video signal source 301, the control unit 340 generates the control signal CTRL of the logic low voltage level “0” to the selecting unit 330, so that the selecting unit 330 outputs the reset signal generated by the reset signal generating module 320 to the display panel 302, so as to initialize the display panel 302.

Then, when the control unit 340 receives the VSS generated by the video signal source 301, the control unit 340 generates the control signal CTRL of the logic high voltage level “1” to the selecting unit 330, so that the selecting unit 330 outputs the processing signal WR generated by the signal masking module 310 to the display panel 302.

At this time, the AND gate 311 in the signal masking module 310 performs an “AND” operation on the data enable signal DE and the masking signal SD, so as to generate the adjusting signal AS. Then, the NAND gate 312 in the signal masking module 310 performs a “NAND” operation on the adjusting signal AS and the clock signal CLK, so as to generate the processing signal WR to the display panel 302.

Then, the display panel 302 displays a part of the current video signal according to the processing signal WR (that is, the masked clock signal CLK), and the action continuous until the end of the data enable.

To sum up, according to the present invention, the signal masking module masks a part of the clock signal of the video signal according to the masking signal and the data enable signal of the video signal, and then the display panel displays the video signal to be the image according to the masked clock signal without converting the video signal through the frame buffer, so as to adjust the resolution of the video signal. In this way, according to the present invention, the extra frame buffer is not required to be configured, therefore, the use cost of the circuit may be effectively reduced and architecture of the portable display apparatus may also be simplified.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable display apparatus of a video signal, comprising:
a video signal source, for generating a data enable signal and a clock signal;
a signal masking module, electrically connected to the video signal source, for receiving the data enable signal and the clock signal, and masking a part of the clock signal according to the data enable signal and a masking signal to provide a processing signal; and
a display panel, electrically connected to the signal masking module, for receiving the processing signal, and displaying a part of the video signal to be an image according to the processing signal.

2. The portable display apparatus of a video signal according to claim 1, further comprising:
a reset signal generating module, for generating a reset signal to initialize the display panel; and
a selecting unit, coupled to the signal masking module and the reset signal generating signal, for selecting to output the reset signal or the processing signal to the display panel according to a control signal.

3. The portable display apparatus of a video signal according to claim 2, wherein the selecting unit is a multiplexer.

4. The portable display apparatus of a video signal according to claim 2, further comprising:
a control unit, coupled to the selecting unit, for receiving a vertical synchronization signal to generate the control signal and the masking signal.

5. The portable display apparatus of a video signal according to claim 1, wherein the signal masking module comprises:
an AND gate, wherein a first input end receives the data enable signal, a second input end receives the masking signal, and an output end generates an adjusting signal; and
a NAND gate, wherein a first input end receives the adjusting signal, a second input end receives the clock signal, and an output end generates the processing signal.

6. The portable display apparatus of a video signal according to claim 1, wherein a resolution of the image is smaller than a resolution of the video signal.
